(19) United States
(12) Patent Application Publication
(10) Pub. No.: US 2010/0043323 A1
(43) Pub. Date: Feb. 25, 2010

(54) INSULATED LOG HOMES

(76) Inventor: Ronald A. Wrightman, Bracebridge, CA (US)

Correspondence Address: BLAKE, CASSELS & GRAYDON LLP, BOX 25, COMMERCE COURT WEST, 199 BAY STREET, SUITE 2800, TORONTO, ON, M5L 1A9, CA

(21) Appl. No.: 12/491,561

(22) Filed: Jun. 25, 2009

Related U.S. Application Data
(60) Provisional application No. 61/090,757, filed on Aug. 21, 2008.

(30) Foreign Application Priority Data
Jun. 25, 2009 (CA) 2,633,134

(51) Int. Cl. E04C 3/29; B05D 3/00; B29C 65/00

(52) U.S. Cl. 52/233; 52/834; 427/299; 156/304.1

(57) ABSTRACT

A log for a log home has a plurality of pockets formed within the body of the log. The pockets are filled with foam to enhance the thermal rating of the log.

### CROSS-REFERENCE TO RELATED APPLICATIONS

This application claims priority from Canadian Patent Application No. 2,633,134 filed on Jun. 25, 2008 and U.S. Provisional Patent Application No. 61/090,757 filed on Aug. 21, 2008 all of which are incorporated by reference.

### FIELD OF THE INVENTION

The present invention relates to logs for use in log homes.

### SUMMARY OF THE INVENTION

It is well known to utilize logs stacked one above another to form the wall of a house. The intersection of logs at corners is accommodated through overlapping joints, either a saddle splined joint or a dovetail joint by providing a connection to a post. Such construction provides an aesthetically pleasing finished product and reflects the traditional values of the environment in which such houses are typically built. Such houses are formed from logs that are rough hewn to shape as they are built into a wall and the gap between the logs sealed with “chinking”. As an alternative to the hand hewn log homes, machined logs have been utilized in the construction. Machined logs have a uniform cross section and the abutting faces of the logs are machined to form a seal system to inhibit the ingress of air between the logs making up the wall. Such construction offers greater thermal efficiency for the building and assists in meeting the air infiltration standards of the relevant building codes.

A further aspect of the building code is the minimum thermal rating, commonly referred to as the R value in North America or U-value in Europe, which is the reciprocal of the R value of the wall. U=5.682/R, taking into account the change in units. The R value for a log is accepted to be R 1.25 per inch and to meet a requirement for a minimum insulation value of R16 it would be necessary to provide 12 inch thick logs. Logs of this dimension are expensive and difficult to obtain in volume and as such make it difficult to attain the minimum values required. It is of course possible to increase the thermal efficiency by insulating the internal surface of the wall but this detracts from the inherent aesthetic value of the log wall construction.

A number of attempts have been made to increase the thermal rating of the log wall material by implementing a thermal break in the log. One of those is shown in PCT application WO 96/07802 in which a plurality of longitudinal slots are cut into the body of the log so as to attempt to provide the necessary thermal efficiency. It is then suggested that thin foam strips can then be set into those cuts. However such an arrangement destroys the integrity of the log and requires careful manufacture in order to ensure that the natural movement of the wood does not result in degradation of the log itself. The logs are invariably machined in a green state and dry over a period of time after assembly. the machining of relatively thin sections leads to the cupping and warping of the sections so that an irregular section of the log is obtained.

Moreover, such an arrangement also makes it difficult for the inter-engaging seal profiles to be manufactured and maintained. The inter engaging profiles are tapered so as to obtain a close fit between the adjacent logs. The sealing material placed between the logs is then compressed as the logs are brought together. Because of the natural movement of the material of the log, an effective seal can only be obtained if the two logs are forced into contact and subsequently held with the seal in a compressed state. This is typically done by using bolts that extend vertically through the wall and tightened to hold the logs together. The bolts may be periodically tightened as the house dries to maintain the compressive load. The tapered profile of the sealing area therefore generates a significant lateral load when the logs are assembled in to a wall that must be resisted if the seal is to remain effective and ingress of air is to be avoided. A log formed by a series of laminar sections does not have the necessary lateral strength to resist the lateral loads imposed and would therefore not offer a practical solution.

Even if those deficiencies are ignored, practically it is not possible to insert or place foam within a narrow slot of the nature described in the above application. Rigid foam cannot be inserted due to the friction occurring between the foam and the sides of the slot, and if a clearance is provided to make this possible a loose fit of the foam is obtained. If the foam is injected, the narrow slots cause the foam to bridge and therefore not fully fill the slots. The force of the expansion is also likely to increase the lateral loading on the thin sections, causing further misalignment and deviation.

Norwegian patent application 173068 similarly describes a log arrangement with thin elongate slots and sections of log and so is subject to the same deficiencies.

Similar deficiencies exist with the arrangements shown in U.S. Pat. Nos. 4,344,263 and 3,992,838. Both of these proposals require a continuous slot filled with foam and extending partially through the log. As such both are susceptible to cupping of the sections of the log and movement in a lateral direction. The Farmont proposal addresses this issue with a metal strap across the groove but this not only increases the cost of the manufacture, it also makes it impractical to adopt the sealing profiles necessary to obtain the air tight seal between logs.

It has also been proposed to laminate a log construction to obtain a thermal break by using inner and outer log panels with a plastic foam block between as shown in WO/95/30807. Such a process, however, is very expensive to produce and has the risk of de-lamination between the foam and the exterior panels given the lifecycle of such a building. De-lamination would subject the foam core to crushing due to the weight of the balance of the logs and as such is not an acceptable practice. The foam would not offer the requisite lateral strength for sealing between the logs.

There is therefore the need for a log construction in which the thermal rating of the log may be increased without destroying the structural integrity of the log.

In general terms the present invention provides a log having a plurality of pockets formed at spaced locations along the log. The pockets are separated by lands constituted by the material of the log that extend transversely between oppositely directed faces of the log. The pockets are filled with an insulating material, typically a foam. The lands are dimensioned to provide sufficient lateral rigidity to withstand forces imposed and maintain the structural integrity of the log.

By providing discreet pockets along the length of the log, the structural integrity of the log is maintained whilst its thermal rating is increased. Sealing profiles may be machined on each of the sealing faces and the terminal portions of the log may be devoid of pockets to permit normal joint construction for the corners.

In one embodiment, the pockets are blind bores extending from an upwardly directed surface of the log and terminating prior to the lower surface. In another embodiment, the bores extend through the log and in a further embodiment the pockets are tapered to receive a tapered plug of pre-foamed foam. Generally the bores are perpendicular to the log surfaces but they may be inclined to increase the cross sectional area if preferred. In a further embodiment, the bores extend between opposed faces of the log so when the logs are stacked, the bores are aligned and provide a continuous column of foam.

### BRIEF DESCRIPTION OF THE DRAWINGS

Embodiments of the invention will now be describing by way of example only with reference to the accompanying drawings in which,

FIG. 1 is a schematic representation of a house having walls formed from logs.

FIG. 2 is a view on the line of II-II of FIG. 1.

FIG. 3 is a side view of a log used in the wall of the house of FIG. 1.

FIG. 4 is an end view of the log of FIG. 3.

FIG. 5 is a section on the line V-V of FIG. 3.

FIG. 6 is a plan view of the log of FIG. 3.

FIG. 7 is a plan view of an alternative embodiment of log.

FIG. 8 is a view similar to FIG. 6 showing a further embodiment of log.

FIG. 9 is a view similar to FIG. 8 showing a further embodiment of log.

FIG. 10 is a side view similar to FIG. 3 showing an alternative configuration of log.

FIG. 11 is a section on the line XI-XI of FIG. 10.

FIG. 12 is an end view similar to FIG. 4 showing the manufacture of the log of FIG. 4.

FIG. 13 is a side view of an alternative log

FIG. 14 is an end view of the log of FIG. 10 showing a method of manufacturing the log of FIG. 13.

FIG. 15 is a plan view of a further alternative embodiment of plug.

FIG. 16 is a perspective view of an alternative embodiment.

FIG. 17 is an end elevation of the embodiment of FIG. 16.

### DETAILED DESCRIPTION OF THE INVENTION

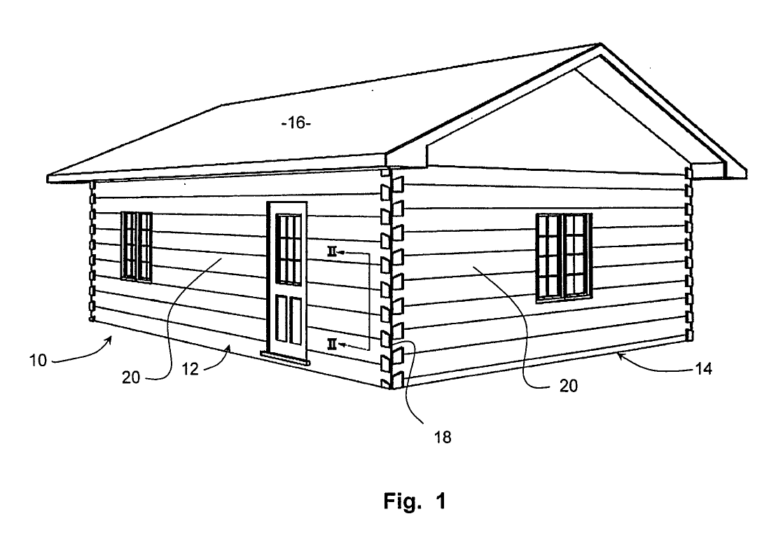

Referring therefore to the drawings, in FIG. 1 a house 10 has side walls 12, 14 that support a roof 16. The side walls 12, 14 intersect at a corner 18.

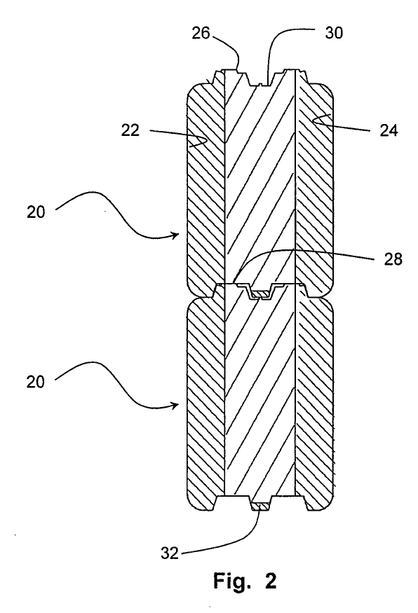

Each of the walls 12, 14 is formed from a plurality of logs 20 that extend horizontally and are stacked one above another in a vertical direction. As can be seen in FIG. 2, the logs 20 have a pair of oppositely directed surfaces, designated an outer surface 22 and an inner surface 24. The outer surface 22 and inner surface 24 are interconnected by an upwardly directed surface 26 and a downwardly directed surface 28, it being understood that the terms upper and lower refers to the normal orientation of the logs 20 when assembled into a wall 12,14. The upper and lower surfaces 26, 28 are milled to have complimentary profiles 30,32 such that when stacked one above the other, the profile 32 of lower surface 28 is snugly received on the profile 30 of the upper surface 26. Seals may be incorporated between the tongue and groove formations to provide an effective seal during the inevitable movement of the logs, as more fully described in co-pending Canadian application number 2,557,364.

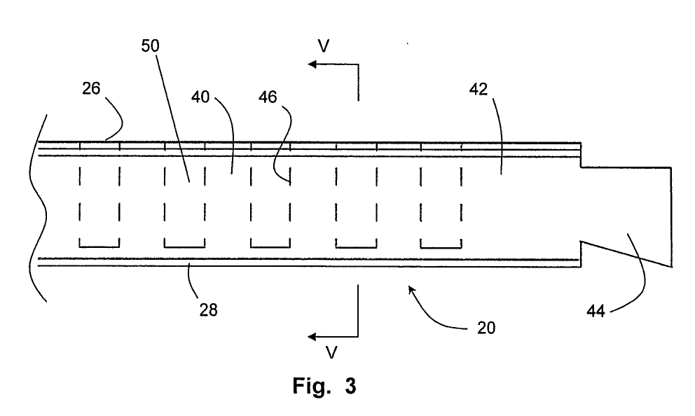

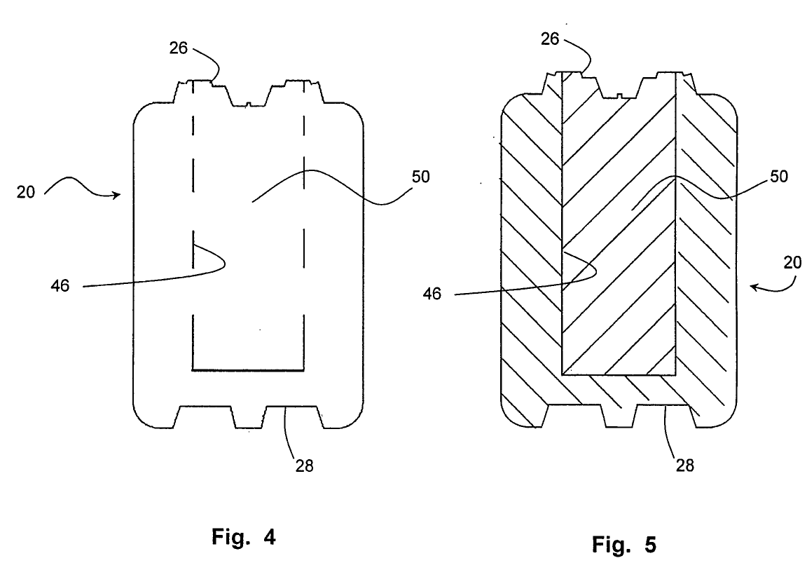

The log 20 is shown in greater detail in FIGS. 3 to 6 from which it will be seen that it has an elongate body portion 40 with a terminal portion 42. The terminal portion 42 is provided to accommodate a joint that cooperates with a log 20 of an adjacent wall at the corner 18 to interlock the two walls 12,14. As shown in FIG. 3, the terminal portion 42 is provided with a tail 44 that forms one-half of a dovetail joint. It will be appreciated that other constructions may be utilized, such as a saddle joint.

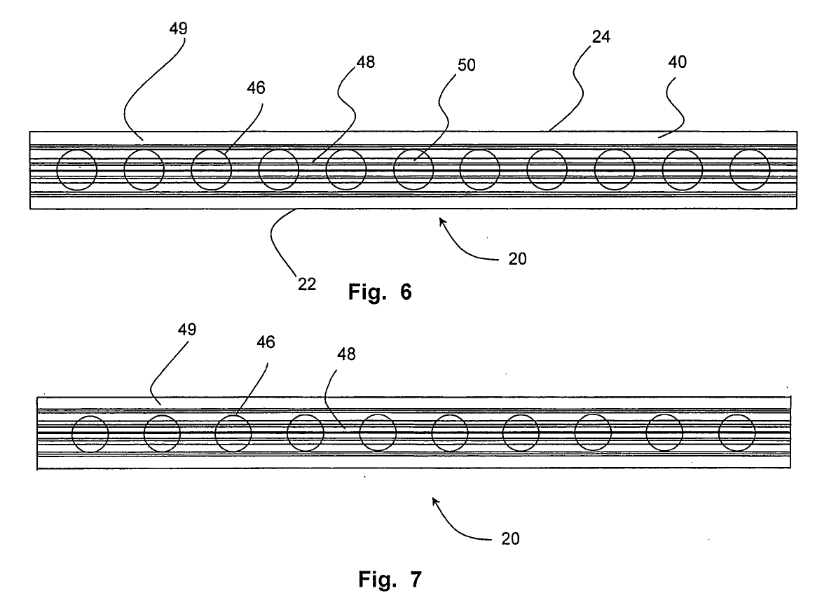

The body portion 40 is formed with a plurality of pockets each defined by bores 46 that extend from the upper surface 26 toward the lower surface 28. In the embodiment of FIG. 3, the bore 46 is of constant circular cross section and is formed by drilling from the upper surface 26 toward the lower surface 28. The bores 46 are uniformly distributed along the body 40 and have a diameter less than the spacing between the inner and outer walls 22, 24. In a typical embodiment as shown in FIG. 6, a log 20 with a nominal spacing of eight inches between the outer face 22 and inner face 24 is provided with bores 46 having a diameter of four inches. The bores 46 are spaced apart on seven inch centres providing a three inch land 48 between each of the bores 46. With the bores 46 spaced apart on the centre line of the log 20, a nominal two inch boundary layer 49 is provided between the bore 46 and the surfaces 22, 24 respectively. The bore 46 terminates prior to the lower surface 28 and provides a minimum thickness in the order of 1 inch.

The bore 46 is filled with a expanded foam plug 50 that extends up to the upper surface 26 and is formed to have the same profile as the upper surface 26, as will be described below. The foam plug 50 is typically a closed cell foam such as urethane having a high thermal insulation value. Typically such foams have an insulation of R6 per inch and a suitable foam is available from Polyurethane Foam Systems Inc. of Waterloo, Ontario under the trade name Polarfoam PF-6352-0.

The foam plug 50 may be formed in situ using the bore 46 as a mould. In this case, the lower face of the bore 46 provides a closed vessel to permit pouring of the liquid foam.

With the configuration of pockets shown in FIG. 6, the insulation value of the log is increased from 1.03 per inch, that is R10.4 to an average value of 20.6. This increased thermal rating is achieved without affecting the structural integrity or the ability of the log to provide an efficient sealing system in the wall. It should be noted that the end portions 42 are maintained to permit the corner joints to be formed out of solid material with the body 40 offering a higher thermal efficiency. The provision of the end face of the bore 46 provides sufficient transverse strength to inhibit splitting of the log 20 when the profiles 30,32 are engaged.

The provision of the bores 46 is also beneficial to the production of the logs 20. By pre-drilling the logs 20 with the bores 46 they may be stored upside down to prevent water collecting in the bores 46. The provision of the bores 46 decreases the drying time of the log 20 significantly from the typical twelve months, allowing the inventory of log 20 to be reduced. Moreover the whole structure also has the effect of stress relieving the log 20 and thereby reducing the surface cracking that is typically present on the surfaces 22, 24. Such surface cracking does not reduce the overall strength of the log 20 but it is aesthetically displeasing. The cracking that does occur will take place on the upper surface 26 between the pockets, thereby enhancing the thermal efficiency of the lands 48 without adversely affecting the structural strength.

The logs 20 as shown in the embodiments of FIGS. 1 through 6 may be produced by initially machining the log blank and drilling the bores 46. The log 20 is then left to dry until the required moisture content is attained, after which the foam plug 50 is formed in each of the bores 46. The plug material is mixed in a liquid form and placed into bores 46 where it forms in situ. Thereafter, as shown in FIG. 12, the upper and lower surfaces 26, 28 are machined to the requisite profile and the tails 44 machined to provide the required joint. The foam plug 50 is supported on all sides by the walls of the bore 46 and therefore milling of the upper face 26 can be accomplished with the foam core in situ. With the upper and lower surfaces 26, 28 formed, the log can then be assembled into a wall having the requisite thermal rating.

It will be appreciated that the extent of the body 40 may vary from log to log to accommodate features of the building 10 such as doorways and windows. It that event, the end portions 42 may be left solid to accommodate joints or other fixtures, but logs extending across such openings can have the foam plugs 50. The configuration of the bores 46 may vary according to different requirements. For example, in FIG. 7, the nominal width of the log 20 is 8 inches and bores 46 are 4 inch diameter. The bores 46 are arranged on 8 inch centres providing a 4 inch land 48 and a two inch boundary layer 49. With this configuration an average thermal rating of R 19.4 is obtained.

In general terms, the lands 48 have a dimension along the longitudinal axis of the log, referred to as the thickness of the land, that is sufficient to withstand the lateral forces imposed on the log. The lands 48 provide a continuous web between the boundary layers 49, which, when combined with the dimensions of the bores 46, inhibit spreading of the inner and outer surfaces 22,24. Typically, the thickness of the land 48 is greater than the minimum boundary layer 49. The thickness of the land 49 is also less than the longitudinal dimension of the bore 46. Preferably, the bores 46 have an aspect ratio, that is the ratio of the longitudinal dimension to the lateral dimension, that is not greater than 2:1 so that the lateral or transverse dimension of the bore 46 is at least 50% of the longitudinal dimension. The dimensions may be adjusted to suit the logs involved and attain the average thermal rating required by the building code.

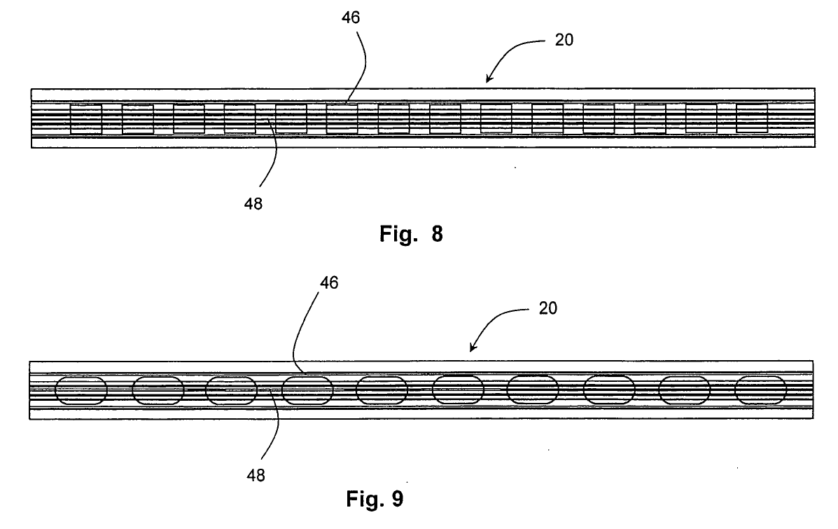

The bores 46 may also be manufactured with varying cross sections as shown in FIGS. 8 and 9. In the embodiment of FIG. 8, the bores 46 are formed with a square cross section provided by a chain mortiser. In the arrangement of FIG. 8, a nominal eight inch log is formed with the bores 46 with four inch sides and on a seven inch spacing. This provides a land 48 of three inches but the volume of foam provided in the bore 46 is increased compared to a circular cross section. As such, an increase in the order of 25% of the cross sectional area of the foam is obtained to increase the average thermal rating to a value of R=23.4.

In the embodiment of FIG. 9, the bore 46 are formed from a pair of overlapping circular bores 46 to present an oval cross section. The bores 46 have a 5 by a 2½ dimensions and the land 48 between the holes is in the order of 3 inches. This provides an R value in the order of R 30.0.

As shown on Table 1 below, a number of different configurations may be used to obtain the desired increase in R-value with relatively few pockets. In the first configuration shown in row 1, circular bores of 3 inch radius extend through the log and are spaced apart by a land of 21.5 inch. Surprisingly, the R value of the log is increased from 10.4 to 16.3, which is sufficient to meet the Canadian building code requirements. This increase is attained with a relatively small number of pockets which maintains the integrity of the log.

Similar results are shown in row 2 where square pockets are spaced apart 24 inches to get a similar increase in R value. With overlapping circular bores of 3 inch diameter, as shown in row 3, a land of 35 inches may be used and with an elongated oval, as shown in row 4, a spacing of 45 inches is possible whilst maintaining an R-value above 16.

An array of smaller diameter staggered pockets, as shown in row 5, may also be used to attain the required value.

TABLE 1
‘Insulated’ Log R-value Calculator

| | | | | | U-value | U-value |
|---|---|---|---|---|---|---|
| | | % foam | % log | R-value | BTU/hr/sq ft/deg F | W/sq m/C |
| 1. Top View of log | | | | | | |
| 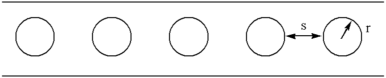 | s (in) = 21.5 r (in) = 3 | 13% | 87% | 16.3 | 0.061 | 0.349 |
| 2. Top View of log | | | | | | |
| 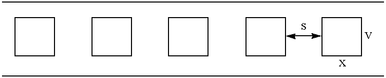 | s (in) = 24 x (in) = 5.5 y (in) = 5.5 | 13% | 87% | 16.2 | 0.062 | 0.349 |
| 3. Top View of log | | | | | | |
| 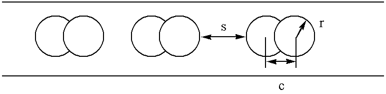 | s (in) = 35 r (in) = 3 c (in) = 3 | 13% | 87% | 16.3 | 0.061 | 0.348 |
| 4. Top View of log | | | | | | |
| 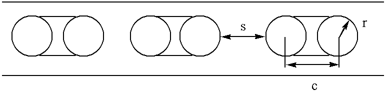 | s (in) = 46 r (in) = 3 c (in) = 5 | 13% | 87% | 16.2 | 0.062 | 0.350 |
| 5. Top View of log | | | | | | |
| 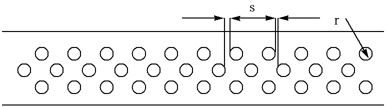 | s (in) = 2.5 r (in) = 1 | 13% | 87% | 16.4 | 0.061 | 0.347 |

Log Width (in) 8
R-log (per in) 1.3
R-value (log only) 10.4
R-foam (per in) 7
Minimum value for Canada is R = 12
Maximum value in the UK is R = 0.35 W/sq m/C

From the above, it will be seen that a variety of configurations may be adopted to obtain the requisite thermal rating, and that where a particular rating is required, the ratio of foam filled pockets to original log may be adjusted to provide this. As shown below in Table 2, reducing the pocket cross section and the spacing enables the same thermal rating to be achieved as the equivalent configuration in table A, thereby illustrating the versatility of the arrangement when meeting particular building requirements, such as interconnecting walls and services.

TABLE 2
‘Insulated’ Log R-value Calculator

| | | | | | U-value | U-value |
|---|---|---|---|---|---|---|
| | | % foam | % log | R-value | BTU/hr/sq ft/deg F | W/sq m/C |
| 1. Top View of log | | | | | | |
| 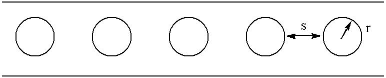 | s (in) = 4.5 r (in) = 2 | 25% | 75% | 16.2 | 0.062 | 0.350 |
| 2. Top View of log | | | | | | |
| 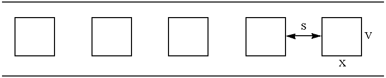 | s (in) = 3 x (in) = 3 y (in) = 3 | 25% | 75% | 16.4 | 0.061 | 0.347 |
| 3. Top View of log | | | | | | |
| 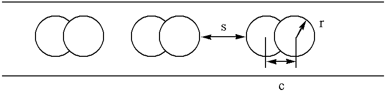 | s (in) = 9 r (in) = 2 c (in) = 4 | 25% | 75% | 16.2 | 0.062 | 0.350 |
| 4. Top View of log | | | | | | |
| 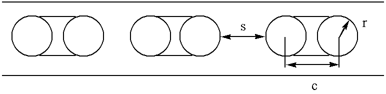 | s (in) = 11.25 r (in) = 2 c (in) = 4 | 25% | 75% | 16.3 | 0.062 | 0.349 |
| 5. Top View of log | | | | | | |
| 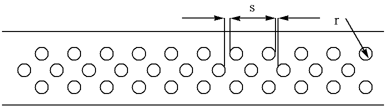 | s (in) = 0 r (in) = 0.625 | 25% | 75% | 16.2 | 0.062 | 0.350 |

Log Width (in) 6
R-log (per in) 1.3
R-value (log only) 7.8
R-foam (per in) 7
Minimum value for Canada is R = 12
Maximum value in the UK is U = 0.35 W/sq m/C

In each of the above embodiments, the bore 46 is of uniform cross section and terminates prior to the lower surface 28. The bores 46 may of course extend through the log, provided provision is made for inserting the foam. When the bore extends fully through the log, as illustrated in FIG. 12, the foam may be machined on both the upper and lower faces. Moreover, when the logs are stacked in a wall, the bores 46 are vertically aligned to provided a continuous vertical column of foam in the wall.

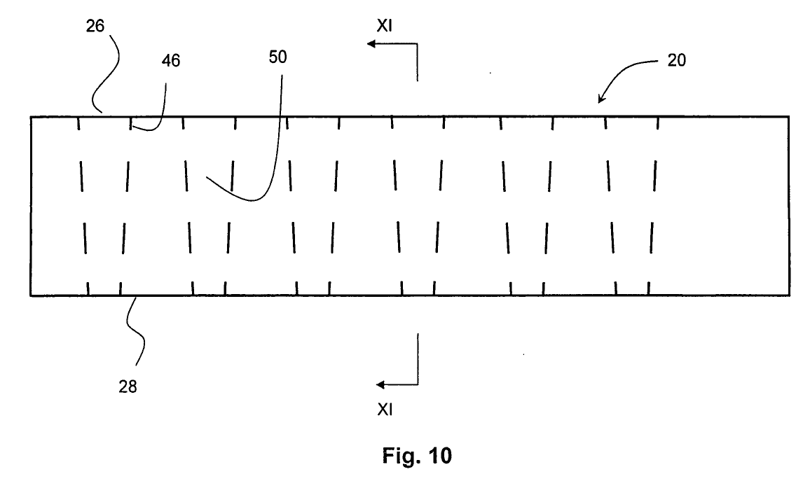

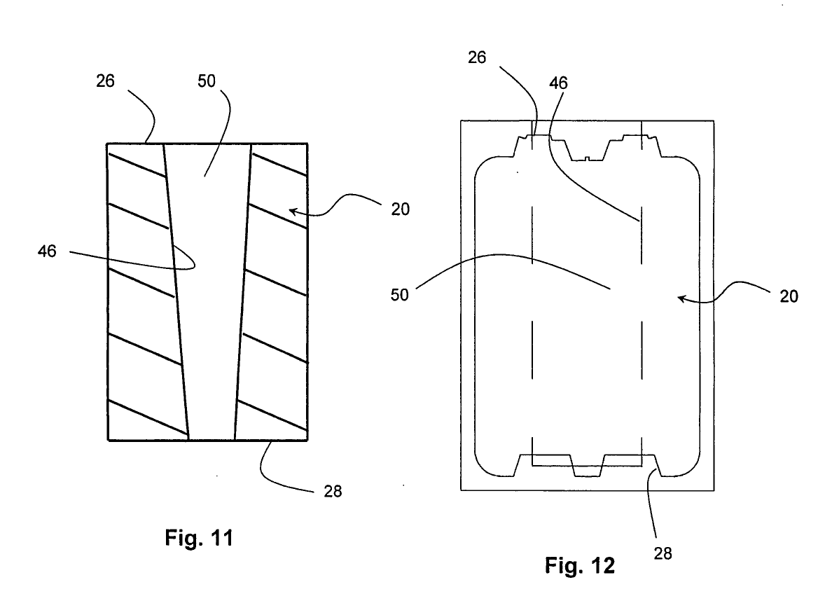

It will also be appreciated that the cross sectional area of the bore 46 may be increased by inclining the axis of the bore 46. In the embodiment shown in FIG. 10 and 11, the bore 46 is formed with a tapered cross section and extends between the opposite faces of the log 20. The tapered cross section permits pre-formed plugs 50 that are also tapered to be inserted into the bores 46 where a tight fit is ensured by virtue of the taper. This arrangement permits the advantages of the increased thermal rating to be obtained without requiring onsite storage of foaming materials and related material handling concerns. With the arrangement shown in FIG. 10 and 11, the plug may be inserted, secured within the bore 46 and the upper and lower surfaces 26, 28 machined to provide the finished log 20.

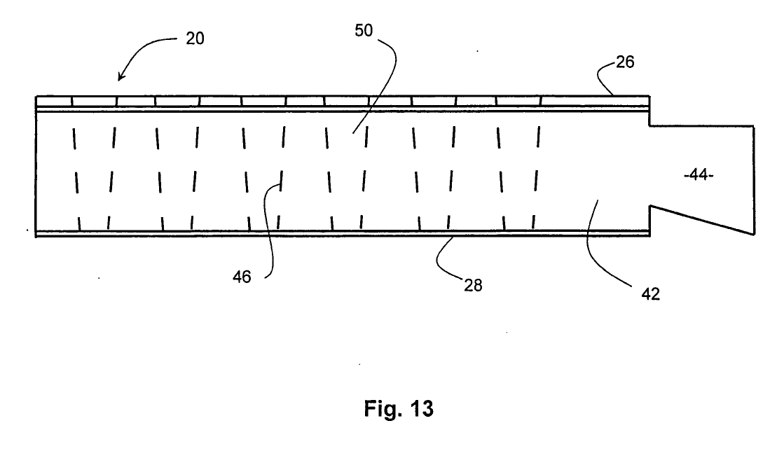

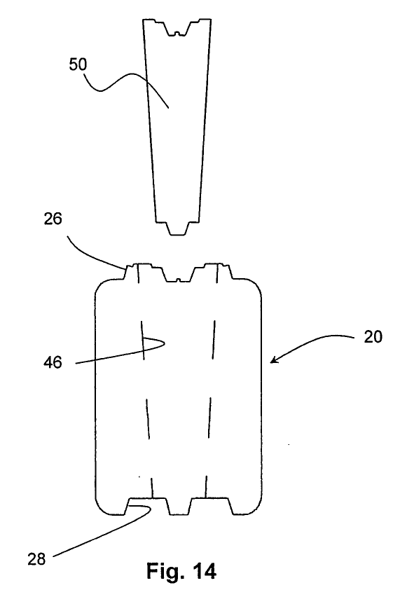

In an alternative arrangement as shown in FIGS. 13 and 14, the tapered plug 50 is preformed with the profile of the upper and lower surfaces at respective ends of the plug 50. The plugs 50 may then be inserted into the pre-bored log 20 with the profiles at opposite ends of the plug 50 matching those of the surfaces 26,28. Such an arrangement permits the log to be assembled in situ where this is preferable.

It will be appreciated of course that the arrangement shown in FIG. 13 and 14 may also be applied to a bore 46 of uniform cross section allowing through bores 46 to be formed in the log and the subsequent installation of cylindrical plugs 50. Such an arrangement would require a sleeved press to insert the plugs but would also permit the use of a cylindrical extrusion cut to length prior to insertion rather than the in situ foaming as described above.

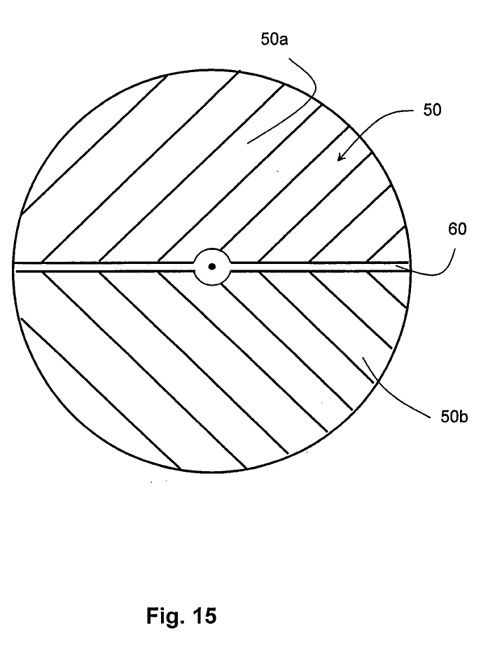

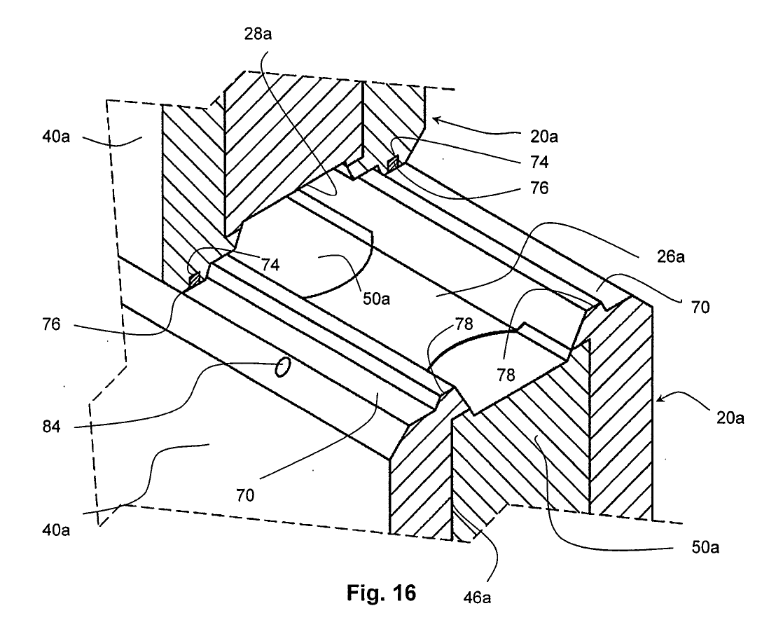

To facilitate insertion of preformed plugs, the arrangement shown in FIG. 15 may be used. As shown in FIG. 15, the plug 50 is formed as two part cylindrical portions, 50a, 50b. Each portion 50a, 50b is slightly less than one half the cross section of the bore 46 providing a gap 60 between the portions 50a, 50b when inserted.

The portions 50a, 50b are held in situ by a wedging action in the gap 60. In one embodiment, the gap 60 is filled with expandable foam which expands to hold the portions 50a, 50b, and the relatively small gap enables the foam to be supplied by pressurised containers if on site installation is required.

It will be seen therefore that the provision of the pockets in the log 20 provides an opportunity to increase the thermal rating without adversely affecting the integrity of the log. The lands between each of the bores ensure that the inner and outer faces are secured at all times to one another and also provides sufficient strength to avoid crushing of the log. The provision of the foam also allows the sealed profiles to be machined in the plug together with the balance of the sealing faces and for the log to maintain the integrity of the end portions for conventional joining techniques.

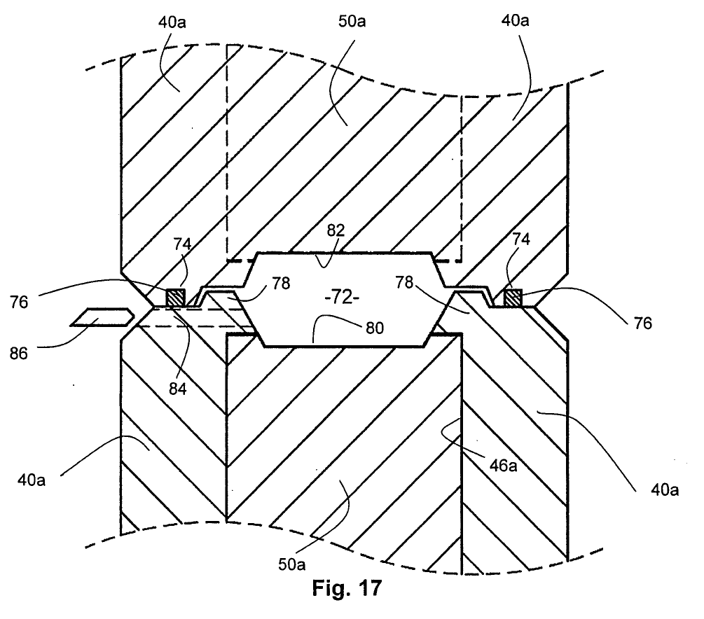

A further embodiment of log is shown in FIGS. 16 and 17, in which like components will be described with like reference numerals with a suffix “a” added for clarity. In the embodiment of FIG. 16, logs 20a are formed as described above to have an elongated body portion 40a and bores 46a. The bores 46a are filled with an expanded foam plug 50a, either in situ or as preformed plugs, that extend along the oppositely directed upper and lower surfaces 26a, 28a.

The upper surface 26a and lower surface 20a are configured to provide opposed, abutting ledges 70 and an internal cavity 72 when the logs 20a are assembled. One of the ledges 70, on the lower surface 2 8a in the embodiment of FIG. 16, is formed with a groove 74 to receive a seal 76 to seal against the oppositely directed ledge 70 of the adjacent log. The seal 76 may be a butyl rubber or foam seal impregnated with asphalt and is effective to seal between the abutting ledges 70.

The cavity 72 is formed between the ledges 70 in the centre portion of the upper surface 26a and lower surface 28a. The upper surface 26a is formed with an upstanding shoulder 78 inboard of the ledges 70 and a recessed channel 80 that extends downwardly to intersect the foam plug 50a.

The lower surface 28 is similarly formed with a central recess 82 that extends to the plug 50a and is spaced from the shoulders 78.

It will be appreciated that the shoulders 78, channel 80 and recess 82 extend the length of the log as a uniform cross section and may terminate prior to the end sections to allow the conventional joint to be manufactured.

A series of lateral holes 84 are machined from one side of the log 20a so as to intersect the channel 80 at regular intervals. The holes 84 are spaced along the length of the log and are of sufficient diameter to allow a foaming wand to be inserted into the hole 84.

To assemble a wall using the embodiment of FIG. 16, the logs 20a incorporating the foam plugs 50a are stacked one above the other with the seals 76 forming an air tight seal between abutting ledges 70. With the wall assembled, foam is injected through the holes 84 so as to fill the cavity 72. The injection occurs along the length of the log at each of the holes 84 until the cavity 72 is filled. The seals 76 effectively inhibit the egress of foam from the cavity so that the foam is contained in the cavity along the length of the log. Thereafter, wooden plugs 86 are inserted into the holes 84 to present a aesthetically pleasing finish to the logs.

The foam utilized in the preferred embodiment is a foamed polyurethane product such as the that sold under the name “Insulator” available from NCFI Polyurethanes of Airy NC and provides adherence to the wood of the log 20a to inhibit separation of the logs 20a. The preferred foam is a two component, one to one by volume self adhering seamless high efficiency rigid polyurethane foam adhesive system. The product identified as NCFI 11-018 has been found suitable. The foam provides insulative properties and adheres to the logs 20a to connect the two opposed faced. The foam injected into the channel 72 therefore not only acts as a thermal insulation between the logs 20a but also acts to secure the logs 20a to one another to provide an integral wall. Separation of the logs 20a as they dry is therefore inhibited and ingress of air between the logs 20a inhibited.

The building may be assembled in a conventional manner by stacking the logs 20a one above the other with the shoulders 78 locating the logs laterally. Tie bolts may be inserted through the logs in a conventional manner to provide an initial setting of the logs 20a.

Once assembled, the foam is then injected into the cavity 72 to fill the cavity and secure the logs to one another.

Once foamed, the plugs are inserted and the building may be finished. Thereafter, the relative movement between adjacent logs 20a due to changes in humidity is inhibited by the adhesion of the foam with the cavity.

Although the invention has been described with reference to certain specific embodiments, various modifications thereof will be apparent to those skilled in the art without departing from the spirit and scope of the invention as outlined in the claims appended hereto. The entire disclosures of all references recited above are incorporated herein by reference.

1) A log having an elongate body with a pair of oppositely directed wall faces extending between a pair of oppositely directed sealing faces, a plurality of pockets extending from one of said sealing faces through said body to the other of said sealing faces, said pockets being and uniformly spaced along said body, said pockets being separated from one another by lands extending between said wall faces said pockets and lands being dimensioned relative to one another to preserve structural integrity of said log and maintain relative spacing of said wall faces.

2) A log according to claim 1 wherein terminal portions of said body are devoid of pockets.

3) A log according to claim 1 wherein said sealing face has sealing formations formed thereon for engagement with a complimentary formation on an adjacent log.

4) A log according to claim 1 wherein said land between pockets has a dimension measured along the longitudinal axis less than the corresponding dimension of said pocket but greater than the spacing of said wall faces from a periphery of said pocket.

5) A log according to claim 1 wherein said pockets are of substantially constant cross section.

6) A log according to any claim 1 wherein said pockets taper.

7) A log according to claim 1 wherein said pockets are distributed and sized to provide an increased in thermal rating of said log to at least R16 when said pockets are filled with foam.

8) A log according to claim 1 wherein said pockets are filled with foam.

9) A log according to claim 8 wherein said foam is preformed and inserted in to said pockets as plugs.

10) A log according to claim 9 wherein a pair of plugs is inserted in a pocket and retained by a wedge spreading said plugs.

11) A log according to claim 9 wherein said plug and pocket are tapered and said plug is retained by interference between said pocket and said plug.

12) A log according to claim 1 wherein said pocket has a dimension between said wall faces of 50% of the spacing between said wall faces.

13) A log according to claim 1 wherein said pockets are circular.

14) A log according to claim 1 wherein said pockets are square.

15) A log according to claim 1 wherein said pockets are oval.

16) A building including at least one log according to claim 1.

17) A building according to claim 16 wherein intersecting walls of said building are formed with a log according to claim 1 and wherein terminal portions of said logs are devoid of pockets.

18) A building according to claim 17 wherein said terminal portions are formed as interlocking joints.

19) A method of forming a log having a pair of oppositely directed sealing faces, said method comprising the steps of forming a plurality of pockets in said log at uniformly spaced intervals along said body, said pockets extending from one of said sealing faces through said log to the other of said sealing faces said pockets being spaced apart greater than the dimension of said pocket along the axis of said long to provide a land extending between said pockets and filling said pockets with insulating foam.

20) A method according to claim 19 including the step of machining formations on said one face after said foam is formed in said pockets.

21) A method according to claim 19 wherein said foam is preformed and inserted in to said bores.

22) A method according to claim 21 wherein said pocket is tapered and said foam is preformed with a complementary taper.

23) A method according to claim 21 where said foam is inserted in said pocket as a pair of portions and retained in said pocket by a wedge acting between said portions.

24) A method according to claim 23 wherein said wedge is a foam inserted between said portions.

25) A log having an elongate body with a pair of oppositely directed wall faces extending between a pair of oppositely directed sealing faces, a plurality of pockets extending from one of said sealing faces into said body and uniformly spaced along said body, said pockets being separated from one another by lands extending continuously between said wall faces each of said pockets having a dimension measured in a direction transverse of said walls that is not less than 50% of the spacing between said walls, said pockets and lands being dimensioned relative to one another to preserve the structural integrity of said log and to maintain relative spacing of said wall faces.

26) A log according to claim 25 wherein said lands have a dimension measured along the longitudinal axis of said log less than the corresponding dimension of said pocket but greater than the spacing of said wall faces from a periphery of said pocket.

27) A log according to claim 25 wherein said pockets have a combined volume that is at least 20% of the volume of said log.

28) A log according to claim 25 wherein said pockets have a transverse dimension at least 50% of the longitudinal dimension.

29) A log according to claims 25 wherein said sealing face has sealing formations formed thereon for engagement with a complimentary formation on an adjacent log.

30) A log according to claim 25 wherein said pockets extend between said sealing faces.

31) A log according to claim 25 wherein said pockets are of substantially constant cross section.

32) A log according to claim 25 wherein said pockets taper.

33) A log according to claim 25 wherein said pockets are distributed and sized to provide an increased thermal rating of said log to at least R16 when said pockets are filled with foam.

34) A log according to claim 25 wherein said pockets are billed with foam.

35) A log according to claim 34 wherein said foam is preformed and inserted in to said pockets as plugs.

36) A log according to claim 35 wherein a pair of plugs is inserted in a pocket and retained by a wedge spreading said plugs.

37) A log according to claim 35 wherein said plug and pocket are tapered and said plug is retained by interference between said pocket and said plug.

38) A log according to claim 25 wherein terminal portions of said body are devoid of pockets.

39) A log according to claim 25 wherein said pockets are circular.

40) A log according to claim 25 wherein said pockets are square.

41) A log according to claim 25 wherein said pockets are oval.

42) A building including at least one log according to claim 25.

43) A building according to claim 42 wherein intersecting walls of said building are formed with logs according to claim 25 and wherein terminal portions of said logs are devoid of pockets.

44) A building according to claim 43 wherein said terminal portions are formed as interlocking joints.

45) A method of forming a log having a pair of oppositely directed sealing faces and a pair of oppositely directed wall faces, said method comprising the steps of forming a plurality of pockets in said log to extend not less than 50% of the distance between said wall faces and extending from one of said sealing faces to the other of said sealing faces with a land extending between said pockets and filling said pockets with insulating foam.

46) A method according to claim 45 wherein said foam is formed in situ.

47) A method according to claim 45 including the step of machining formations on one of said sealing faces after said foam is formed in said pockets.

48) A method according to claim 45 wherein said foam is preformed and inserted in to said bores.

49) A method according to claim 48 wherein said pocket is tapered and said foam is preformed with a compounding taper.

50) A method according to claim 48 where said foam is inserted in said pocket as a pair of portions and retained in said pocket by a wedge acting between said portions.

51) A method according to claim 50 wherein said wedge is a foam inserted between said portions.

52) A method of forming a wall of a log building by stacking logs vertically one above another with abutting faces cooperating to define an internal cavity and injecting a foam within said cavity after assembly of said logs to connect said logs to one another.

53) A method according to claim 52 wherein pockets are formed in said logs extending from one of said abutting faces prior to assembly of said logs into a wall.

54) A method according to claim 53 wherein foam is inserted in said pockets prior to assembly of said logs into a wall.
